(19) United States
(12) Patent Application Publication
(10) Pub. No.: US 2004/0124720 A1
(43) Pub. Date: Jul. 1, 2004

(54) Stator for a rotary electric machine

(75) Inventors: Dominique Condamin, Angouleme (FR); Jean Gaste, Angouleme (FR); Philippe Murzeau, Angouleme (FR); Eric Boulai, Gond Pontouvre (FR)

Correspondence Address: OLIFF & BERRIDGE, PLC, P.O. BOX 19928, ALEXANDRIA, VA, 22320, US

(73) Assignee: MOTEURS LEROY-SOMER, Angouleme (FR)

(21) Appl. No.: 10/327,977

(22) Filed: Dec. 26, 2002

(51) Int. Cl. H02K 5/24

(52) U.S. Cl. 310/51

(57) ABSTRACT

The present invention relates to a stator for a rotary electric machine, the stator comprising a stator body made up of a stack of stator laminations and first and second nested concentric disposed with clearance about the stator body. First resilient damping elements are placed between the two parts. These resilient damping elements are disposed circumferentially around the inner one of said two parts between the outer surface of said inner part and the facing inner surface of the outer part. Relative movement between the two parts is limited both axially and circumferentially by second damping elements.

The present invention relates to a stator for a rotary electric machine, for example a variable-reluctance motor.

### BACKGROUND OF THE INVENTION

Rotary machines are essentially constituted by a rotor and a stator, the stator being connected to a host structure either directly or via cheekplates, while the rotor is mounted to rotate inside the stator.

Rotary machines, and more particularly variable-reluctance rotary electric machines suffer from the drawback of being noisy because of the noise and vibration generated mainly by the stator.

To filter and damp the noise and vibration generated by the stator of a rotary machine, EP-A-0 957 564 has already proposed making the magnetic circuit of the stator as two concentric cylindrical parts that are nested with clearance, said parts being held spaced apart from each other by a plurality of damping elements that are elongate, resilient, and extend in an axial direction, i.e. along generator lines of the two nested cylindrical parts constituting the magnetic circuit of the stator.

Another problem associated with rotary machines, in particular variable-reluctance rotary electric machines, is the heat given off in operation which makes cooling necessary.

The known implementation of elongate resilient damping elements place along generator lines of the two parts constituting the magnetic circuit of the stator prevents the stator being cooled properly through the outside surface of its magnetic circuit because of the presence of an air space between the two cylindrical parts.

British patent application GB 2 293 695 discloses a variable-reluctance motor having vibration-damping elements between the stator and the motor casing. In the embodiment of FIG. 5 of that application, a ring fixed to the casing exerts axially-directed force on the stator so as to keep it pressed against a damping element that is interposed between the stator and a shoulder of the casing. Such a ring is prejudicial to sound insulation of the motor since it conducts vibration. In addition, the motor shown in FIG. 5 does not enable high torque to be transmitted between the stator and the casing.

### OBJECTS AND SUMMARY OF THE INVENTION

The present invention sets out to provide a stator for a rotary machine that makes it possible to provide good damping of noise and vibration while, where appropriate, enabling a cooling circuit to be integrated in the casing of the stator.

In one of its aspects, the invention provides a stator for a rotary electric machine, the stator comprising:

a stator body comprising a stack of stator laminations;

first and second parts placed around the stator body with clearance between each other;

at least one first damping element placed in such a manner as to limit relative movements in a radial direction between the two parts; and

at least one second damping element placed in such a manner as to limit relative movements in an axial direction and in rotation between the two parts.

In a particular embodiment, the stator comprises a stator body and at least first and second concentric parts nested one in the other with clearance and placed around the stator body, the first resilient damping element being disposed circumferentially, e.g. around the inner one of the two parts between the outside surface of said part and the facing inside surface of the other part, with axial and rotary movements between the two parts being limited by the second damping elements.

The resilient first damping elements may advantageously be annular gaskets, e.g. made of rubber, optionally closed, and where appropriate provided with internal reinforcement, these gaskets possibly being O-rings or presenting arbitrary section, e.g. square, rectangular, with lips, chevron-shaped, etc.

The first damping elements may also be constituted by studs distributed circumferentially. In which case, the damping elements may be interposed between the two concentric parts, for example at more than three points that are angularly spaced apart by more than about 100, and preferably the ratio of 3600 to the selected angular offset is not an integer multiple of the number of poles of the stator.

The first damping elements may be interposed between the two concentric parts at a plurality of points that are optionally regularly distributed, along one or more circumferences.

The second damping element(s) may be constituted, for example, by pins, screws, or pegs that are made completely or partially out of materials having elastic properties and in general by any parts having damping properties.

It will be understood that installing circumferential gaskets closing a defined space between the facing surfaces of the first and second parts makes it possible to provide a duct for passing a cooling liquid in this space and/or the facing surfaces. Thus, a cooling liquid may circulate between the two parts, the machine having at least one inlet and one outlet between which said liquid circulates. It is also possible to select the characteristics of the cooling liquid so as to further increase the damping effect.

The damper element may also be formed by a rolled elastic gasket for example a helically-rolled gasket occupying a length of the stator between the facing surfaces of the first and second concentric parts.

In addition to the two above-specified parts, the stator may have one or more intermediate parts nested concentrically, the first damping elements possibly being disposed as described above in the annular spaces that exist between the respective parts making up the stator.

In a particular embodiment, the two parts are placed around a stack of stator laminations.

The stator may be mounted on a host structure by the outer one of the two parts, optionally via an end cheekplate.

In a particular embodiment, the stator has at least two first damping elements occupying two different axial positions along the axis of the stator.

The clearance between the parts may be substantially equal to 0.1 millimeters (mm), for example.

It is advantageous for the clearance to be small since, in the event of the damping elements being crushed, that makes it possible to avoid the rotor striking the stator. The clearance between the two parts is preferably smaller than the airgap between the rotor and the stator, which is itself generally about 0.5 mm.

In a preferred embodiment, the second damping elements comprise at least one washer interposed between one of the parts and a rigid element secured to the other part. Advantageously, the machine does not have any metal bridge for transmitting vibration between the two parts.

The stator may have screws each carrying a respective washer, the inner part having bores in which the screws can be fixed, the outer part having openings defined by tubular walls, the washers carried by the screws being interposed between the screws and said walls so as to enable torque to be transmitted between said parts while damping vibration.

The washers are advantageously compressed axially so as to prevent any leakage of cooling liquid through said openings, with each washer preferably being compressed axially between the corresponding screw and the inner part.

The screws need not be uniformly distributed angularly.

The axes of the screws may extend radially or parallel to the axis of rotation of the rotor.

The stack of stator laminations may be fixed in one of the parts by a resin injected inside said part after the stack of laminations has been put into place in said part without interference.

At least one of the first damping elements may be pressed between a radially inner first face of one of the parts and a second face of the other part, said second face possibly being radially further in than the first face. This second face may be defined by a folded-over portion of said other part.

The invention also provides a stator for a rotary electric machine in particular a variable-reluctance machine, the stator including at least one washer placed around a rigid element secured to a first part of the stator, said washer being placed in contact with a wall secured to a second part of the stator that is concentric with the first. The axis of the rigid element may be parallel to the axis of rotation of the rotor, or it may be perpendicular thereto.

The washer may serve to transmit torque between the two parts while damping vibration between them, and may also serve to avoid any metal-on-metal contact.

Advantageously, the washer may also serve to prevent a liquid that circulates between the two parts from escaping via an opening defined by a wall against which the washer comes to bear at its periphery. The rigid element may be a screw and the wall against which the washer comes to bear at its periphery may define an opening enabling the screw to be fixed to the stator.

### BRIEF DESCRIPTION OF THE DRAWINGS

In order to make the invention better understood, there follows a description of non-limiting embodiments given with reference to the accompanying drawings, in which:

FIGS. 1 to 3 are diagrammatic section views showing three embodiments of a rotary machine of the invention;

FIG. 4 is a diagrammatic axial section of another example of a rotary machine of the invention;

FIG. 5 is a cross-section on V of FIG. 4;

FIGS. 6 and 7 are perspective views showing a stop screw and the associated gasket;

FIG. 8 is an axial section through a screw and the associated gasket;

FIG. 9 is a perspective view of a machine constituting a variant embodiment;

FIG. 10 is a diagrammatic axial section of the FIG. 9 machine;

FIG. 11 is a diagram showing detail XI of FIG. 10;

FIG. 12 is an end view of another variant embodiment;

FIGS. 13 and 14 are axial sections respectively on XIII-XIII and XIV-XIV of FIG. 12; and

FIG. 15 shows detail XV of FIG. 14.

### MORE DETAILED DESCRIPTION

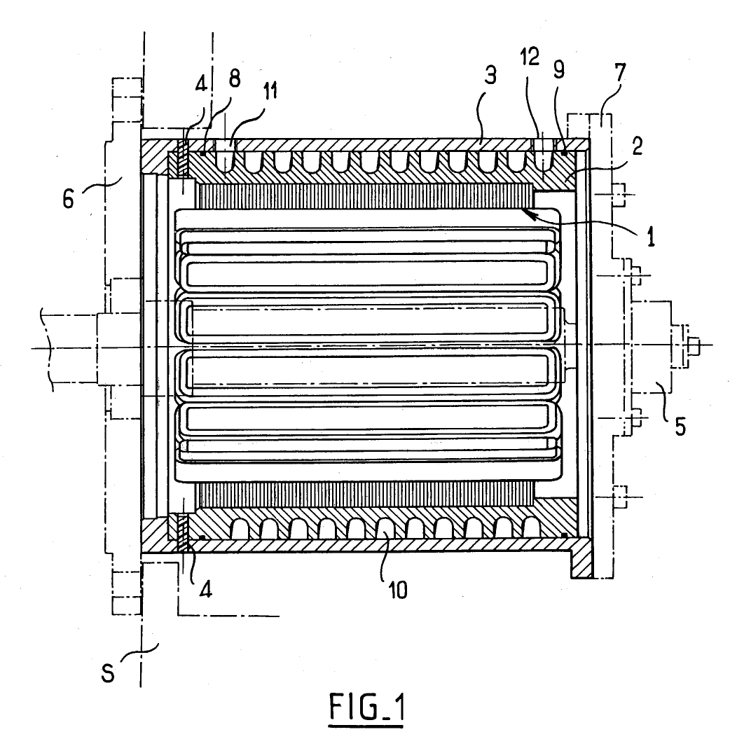

The stator shown in FIG. 1 comprises a stator body made up of a stack of stator magnetic laminations given overall reference 1, and an outer peripheral casing that may be constituted by an inner first part or yoke 2 and an outer second part or yoke 3, the inner part 2 being connected to the stator body 1 as an interference fit or by adhesive, for example.

The parts 2 and 3 constituting the stator casing are disposed concentrically leaving a small amount of clearance between their facing surfaces, for example clearance of about 1/10 mm.

The parts 2 and 3 are positioned axially and in rotation by stop means 4 such as pins, screws, or pegs made at least in part out of damping materials. The stop means serve to transmit torque from the stator body to the outer part 3 of the casing.

In FIG. 1, chain-dotted lines 5??? represent the rotor 5 inside the stator, and end cheekplates 6 and 7 that act as bearings for the rotor, the stator casing being connected to a host structure S via said cheekplates. Annular sealing gaskets 8 and 9 such as rubber O-rings are disposed in the vicinity of the longitudinal ends of the stator between the facing surfaces of the parts 2 and 3 of the stator casing.

A helical duct 10 for conveying a cooling fluid such as water, possibly containing antifreeze, or oil, is provided in the outer peripheral surface of the inner part 2 of the stator, with respective inlet and outlet orifices 11 and 12 being provided in the outer part 3 so as to form a cooling liquid circuit.

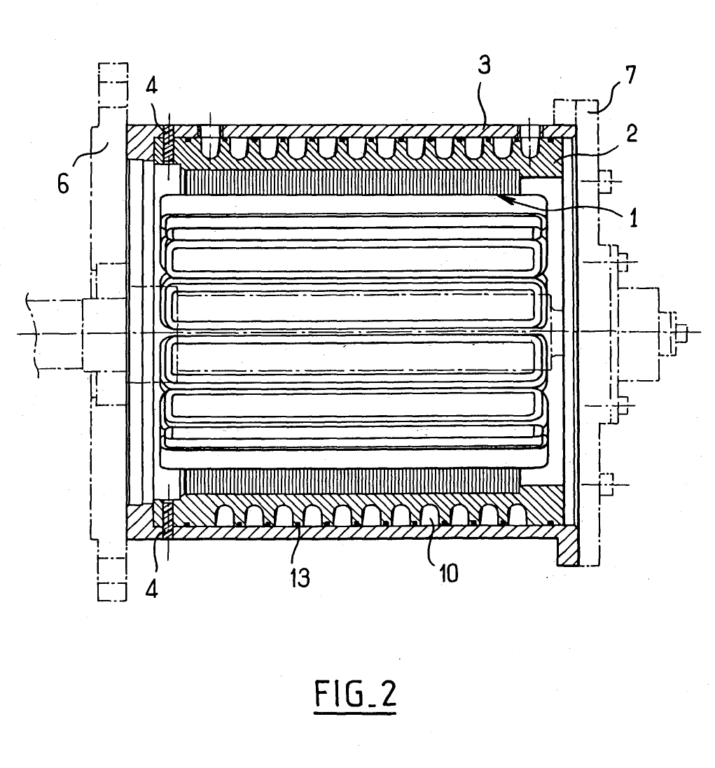

The embodiment shown in FIG. 2 differs from that of FIG. 1 essentially by the fact that the annular gaskets 8 and 9 are replaced by a helical gasket 13 occupying the major fraction of the length of the stator between the facing parts 2 and 3.

With a gasket of this configuration, it is possible where appropriate to provide cooling without making a duct 10, the duct for passing a cooling fluid being obtained merely by suitably dimensioning the helical gasket or else by providing appropriate shape and clearance between the facing parts 2 and 3, in which case the duct is arranged between said gasket and the facing surfaces of the parts 2 and 3.

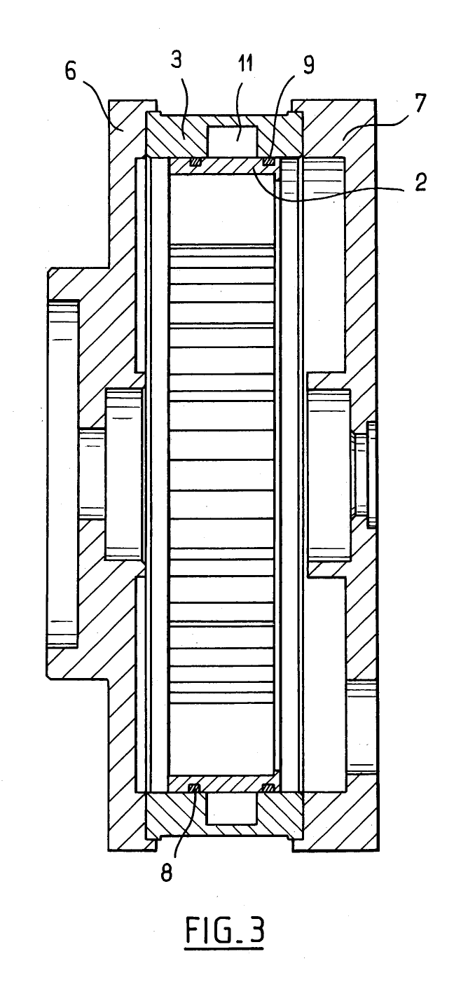

The embodiment shown in FIG. 3 differs from the embodiment of FIG. 1 essentially by the fact that the helical duct 10 is replaced by a single circular duct 11 that is recessed in the outer part 3.

If it is not desired to provide cooling, then it is possible to provide damping elements of types other than closed O-rings, said damping elements being disposed circumferentially between the facing surfaces of the parts 2 and 3 of the stator.

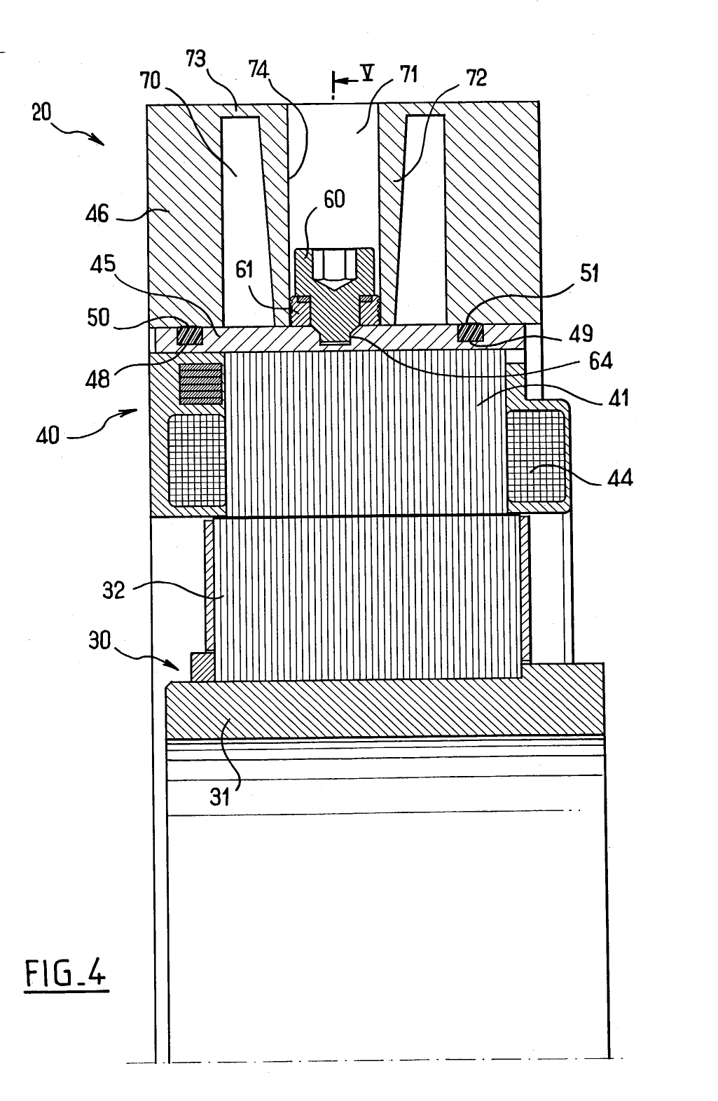

FIG. 4 is an axial section through another rotary electric machine 20 made in accordance with the invention.

In the example shown, this machine is a variable-reluctance motor and comprises a rotor 30 and a stator 40. The rotor 30 has a shaft 31 carrying a stack of magnetic laminations 32.

The stator 40 has a body comprising a stack of magnetic laminations 41 defining teeth 42 and slots 43 for receiving electrical conductors 44. The stack of laminations 41 is received in an inner part or yoke 45.

The part 45 may be an interference fit on the stack of laminations 41, or in a variant, and preferably, the stack of laminations is inserted into the part 45, the coils are put into place, and then a resin is injected and polymerized hot.

The stator 40 has an outer part or yoke 46 nested on the part 45 with clearance being left between them.

The part 45 has two annular grooves 48 and 49 which receive two first damping elements constituted by respective O-rings 50 and 51. The clearance between the part 45 and the part 46 is small, being about 0.1 mm, for example, and the gaskets 50 and 51 are dimensioned so as to occupy the space between the parts 45 and 46 so as to prevent them from touching each other in normal operation of the machine.

Nevertheless, if the parts 45 and 46 do touch, since the clearance between them is less than the airgap between the rotor and the stator, there is no risk of the rotor striking the stator.

Stop means may be provided to limit any axial and circumferential relative movements between the parts 45 and 46, in particular so as to enable torque to be transmitted from the part 45 to the part 46, the part 46 being fixed to a host structure for the machine, for example via end cheekplates.

In the example described, these stop means comprise screws 60 each provided with a second damping element constituted by an elastomer washer 61.

FIGS. 6 and 7 are perspective views and FIG. 8 is a section view showing a screw 60 and its washer 61 in isolation.

Each screw 60 has a threaded end portion 62 for screwing into a tapped bore 64 in the part 45, and at its opposite end it has a socket 68 for co-operating with a hexagonal key. The body of the screw presents a shoulder 66 against which the washer 61 can bear axially via one face. The washer 61 may incorporate a metal reinforcing ring 80. At its outer periphery, the washer 61 presents a series of annular corrugations 67.

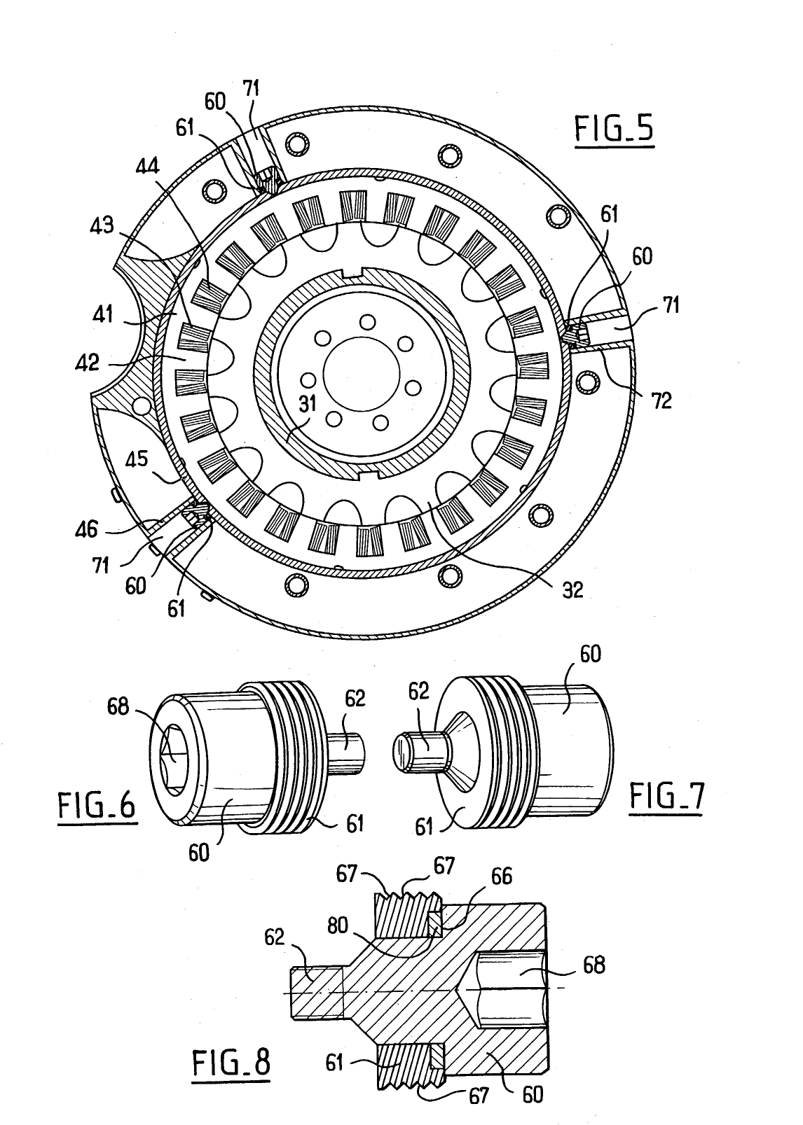

In the example described, there are three screws 60 which are disposed at about 105° from one another, as can be seen in FIG. 5, the axes of the screws being coplanar in a plane situated substantially halfway between the O-rings 50 and 51.

In its inside face, the outer part 46 has an annular groove 70 enabling a cooling liquid to be caused to circulate between the parts 45 and 46, the O-rings 50 and 51 preventing the liquid leaking out through the clearance between the parts 45 and 46. In the vicinity of each screw 60, the part 46 has an opening 71 defined by a generally tubular wall 72 which is connected to the wall 73 of the part 46 that defines the bottom of the groove 70.

By way of example, the wall 72 has a circularly cylindrical inside surface 74 against which the washer 61 comes to bear via the top of the corrugations 76, as can be seen in FIG. 4. The washer 61 is thus interposed radially between the screw 60 and the wall 72, and enables torque to be transmitted while avoiding transmitting vibration from the screw 60 to the part 46. The washer 61 may also close the opening 71 in the part 45 in leaktight manner, thus preventing any cooling liquid from leaking out through the opening 71.

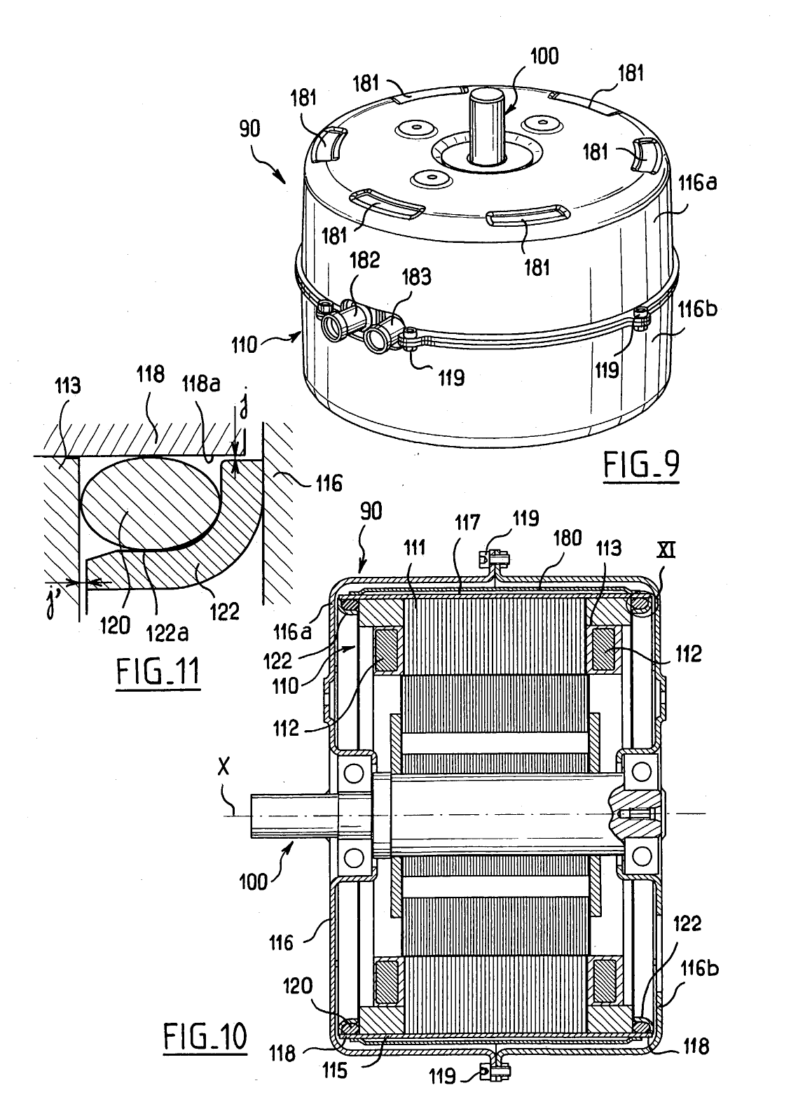

FIGS. 9 to 11 show a machine 90 comprising a rotor 100 which is shown very diagrammatically, for rotating about an axis of rotation X, together with a stator 110 comprising a stack 111 of stator laminations defining teeth having coils placed thereon, with only the heads 112 of the coils being visible in FIG. 10, said coils being embedded in a mass 113 of resin.

The machine 90 has a stator casing comprising first and second parts 115 and 116 defining a space between them in which at least one cooling liquid circulation channel 117 is provided. The channel 117 is formed between the part 115 and an insert 180.

In the example described, the first part 115 is in the form of a cylindrical sleeve about the axis X and presents portions 118 that project axially from each end of the stator body so that each portion defines a bearing face 118a for a first damping element 120 constituted in the example shown by an O-ring 120.

The second part 116 comprises two halves 116a and 116b united by fastener elements, e.g. screw-and-nut pairs 119.

Each half 116a or 116b has a folded-over portion 122 defining a bearing face 122a facing a corresponding portion 118, with one of the first damping elements 120 bearing against the face 112a. Each folded-over portion 122 is constituted in the example described by a ring fitted to the corresponding half of the part 116 and bearing via a fraction only of its circumference against said half, e.g. over six sectors 181 formed by setbacks in its wall extending transversely to the axis X, as can be seen in FIG. 9. This makes it possible to provide passages enabling air to circulate better inside the machine.

The first and second parts 115 and 116 present clearance j between each other between the portions 118 and the folded-over portions 122, as can be seen in FIG. 11 where this clearance j is less than 0.4 mm, for example, being about 0.1 mm, for example. Clearance j′ also exists in a direction parallel to the axis X between the folded-over portions 122 and the mass 113 of resin.

The first damping elements 120 damp radial and axial vibration between the parts 115 and 116.

At least one second damping element (not shown) is interposed between the parts 115 and 116 to limit relative movements in rotation about the axis X. This second damping element is in the form, for example, of a peg as described with reference to FIG. 1 or of a resilient washer as shown in FIG. 8 or of a part which is engaged around endpipes 182 and 183 for cooling liquid inlet and outlet into and from the channel 117 and bearing against the halves 116a and 116b.

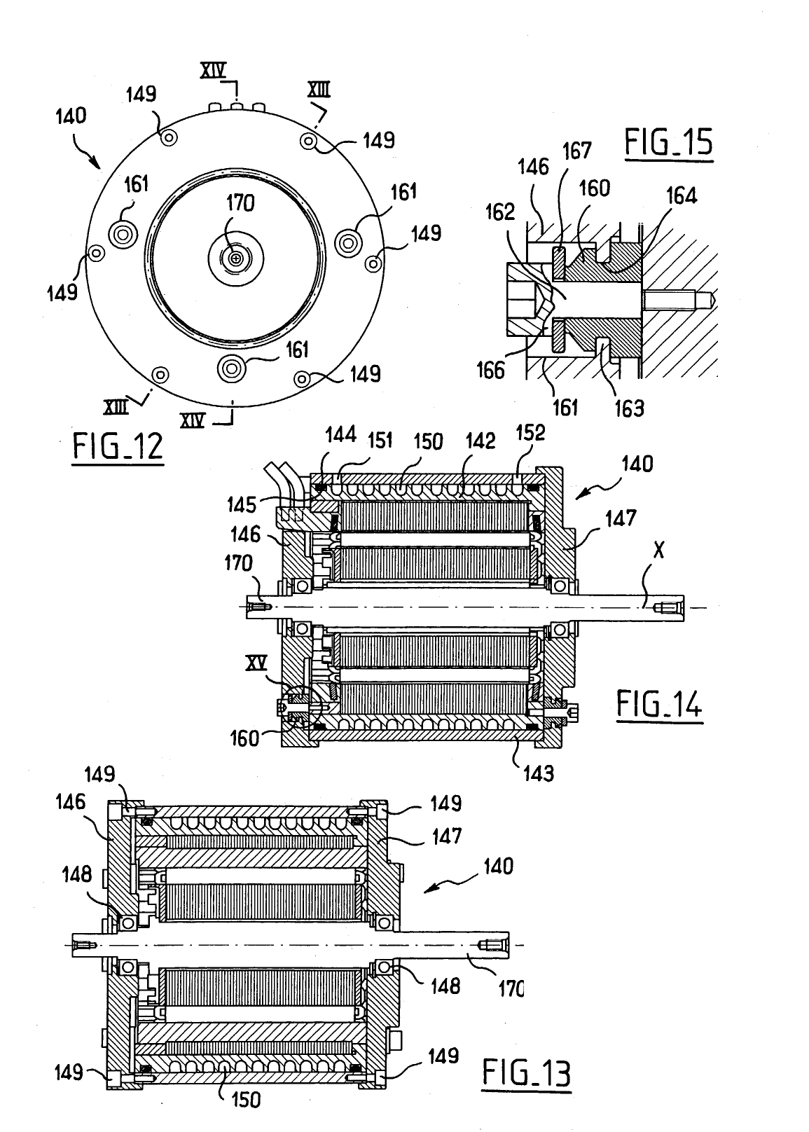

The machine 140 shown in FIGS. 12 to 15 is very similar in structure to the machine shown in FIG. 1, with a stator casing comprising an inner yoke 142 and an outer yoke 143 disposed concentrically, leaving a small amount of clearance between their facing faces, for example clearance of about 0.1 mm.

First damping elements 144 constituted by O-rings in this example are placed in annular grooves 145 of the inner yoke 142 damping relative movement in the radial direction of the inner yoke 142 relative to the outer yoke 143. The outer yoke is secured to end cheekplates 146 and 147 by screws 149.

The cheekplates 146 and 147 carry bearings 148 in which the shaft 170 of the rotor rotates.

As in the example of FIG. 1, the inner yoke has a duct 150 for circulating a cooling liquid between an inlet 151 and an outlet 152.

The pegs 4 of the example shown in FIG. 1 are replaced in the example of FIGS. 12 to 15 by second damping elements 160 each engaged in a hole 161 of one of the cheekplates 146 or 147 and each having a fastened element 162 passing therethrough that is secured to the inner yoke 142, for example that is screwed into a bore therein, extending along an axis parallel to the axis of rotation X of the shaft 170 of the rotor. The second damping elements 160 are in the form of resilient washers, e.g. made of elastomer material.

Each hole 161 has an annular rib 163 engaged in a corresponding groove 164 in the damping element 160 so that the damping element is axially secured to the associated cheekplate 146 or 147.

Each screw 162 has a head 166 that can bear against a rigid washer 167 placed against the damping element 160.

The second damping elements 160 serve to limit relative movements in an axial direction between the inner yoke 142 and the outer yoke 143, and also serve to limit relative movements in rotation about the axis X between the inner yoke 142 and the outer yoke 143, while nevertheless transmitting torque between the stack of stator laminations and the host structure.

Although the invention is described with reference to particular embodiments, it is clear that it is not limited in any way thereto and that numerous variants and modifications may be applied thereto without going beyond its ambit or its spirit.

For example, it is possible to place elastic damping elements between the stator body and the inner part of the casing, and to conserve the gaskets between the inner and outer parts.

That would provide two stages of vibration damping and the properties of the elastic damping elements in each of the stages can be selected so as to filter different frequencies of vibration.

What is claimed is:

1/ A stator for a rotary electric machine, the stator comprising:
a stator body comprising a stack of stator laminations;
first and second parts placed around the stator body with clearance between each other;
at least one first damping element placed in such a manner as to limit relative movements in a radial direction between the two parts; and
at least one second damping element placed in such a manner as to limit relative movements in an axial direction and in rotation between the two parts.

2/ A stator according to claim 1, having first damping elements constituted by O-rings.

3/ A stator according to claim 2, in which the O-rings are two in number.

4/ A stator according to claim 1, in which said at least one first damping element comprises a gasket wound over a length of the stator.

5/ A stator according to claim 1, in which the stator is mounted to a host structure via end cheekplates.

6/ A stator according to claim 1, in which said second damping element comprises at least one washer providing damping properties interposed between one of said parts and a rigid element secured to the other one of said parts.

7/ A stator according to the preceding claim, wherein the washer has corrugations in its periphery.

8/ A stator according to claim 1, including screws each carrying a respective washer, the inner part having bores in which the screws can be fixed, the outer part having openings defined by tubular walls, the washers carried by the screws being interposed between the screws and said walls in order to enable torque to be transmitted between the parts while damping vibration.

9/ A stator according to the preceding claim, in which the axis of at least one screw is radial.

10/ A stator according to claim 8, in which the washers are compressed axially so as to prevent cooling liquid from leaking through said openings.

11/ A stator according to claim 10, in which the axial compression of each washer takes place between a shoulder of the corresponding screw and the inner part.

12/ A stator according to claim 1, having a stack of laminations fixed in one of said parts by resin injected into said part after the stack of laminations have been put into place in said part without interference.

13/ A stator according to claim 1, in which a cooling liquid is present between the two parts.

14/ A stator according to claim 1, in which said at least one damping element is pressed between a radially inner first face of one of the parts and a second face of the other part, said second face being radially further in than the first face.

15/ A stator according to claim 14, wherein the second face is defined by an inwardly-directed portion of said other part.

16/ A stator having at least one resilient washer disposed around a rigid element secured to a first part of the stator, said washer being placed in contact with a wall secured to a second part of the stator, which second part is concentric with the first.

17/ A stator according to claim 16, in which the axis of the rigid element is parallel to the axis of rotation of the rotor.

18/ A stator according to claim 16, in which the axis of the rigid element is perpendicular to the axis of rotation of the rotor.

19/ A stator according to claim 16, in which the washer has an annular groove in which there is received a rib that is secured to said second part.

20/ A stator according to claim 16, in which the rigid element is constituted by a screw.
